(19) United States
(12) Patent Application Publication
(10) Pub. No.: US 2019/0279120 A1
(43) Pub. Date: Sep. 12, 2019

(54) RESERVATION MANAGEMENT SYSTEM, RESERVATION MANAGEMENT METHOD, AND RESERVATION MANAGEMENT PROGRAM

(71) Applicant: Toyota Jidosha Kabushiki Kaisha, Toyota-shi Aichi-ken (JP)

(72) Inventors: Koichi Suzuki, Toyota-shi Aichi-ken (JP); Katsunori Takami, Toyota-shi Aichi-ken (JP)

(21) Appl. No.: 16/289,944

(22) Filed: Mar. 1, 2019

(30) Foreign Application Priority Data
Mar. 6, 2018 (JP) 2018-040113

(51) Int. Cl. G06Q 10/02; G06F 16/9536

(52) U.S. Cl. CPC G06Q 10/02; G06F 16/9536

(57) ABSTRACT

A reservation management system includes: a vehicle information management unit that manages vehicle information including availability information of each of a plurality of car-sharing cars and information on an on-vehicle device; a facility information management unit that manages facility information; a receiving unit that receives, as a search condition for retrieving the car-sharing car, information related to a purpose of use of a user from a communication terminal of the user; a retrieving unit that retrieves one or more candidates for car-sharing cars conforming to the purpose of use on the basis of the vehicle information and the facility information; a transmitting unit that transmits information related to the retrieved candidates for car-sharing cars to the communication terminal; and a reservation receiving unit that receives a reservation for a car-sharing car selected by the user among the candidates for car-sharing cars.

### CROSS-REFERENCE TO RELATED APPLICATION

This application claims priority to Japanese Patent Application No. 2018-040113, filed Mar. 6 2018, incorporated herein by reference in its entirety.

### BACKGROUND

### Field

The present disclosure relates to a reservation management system, a reservation management method, and a reservation management program.

### Description of Related Art

With development of information communication technology and change in lifestyle or for economical reasons, an era in which people own things has changed to an era in which people share things within a community. Car sharing enables users who are members to share vehicles and to check for the use states of vehicles and make a reservation through the Internet or the like. As a system for allowing users to select a desired vehicle, as disclosed in Patent Publication JP-A-2003-12318 for example, a system for retrieving an optimal vehicle on the basis of a priority order associated with each of a plurality of search conditions (vehicle type, usage, charge, and the like) is known.

### SUMMARY

However, when a rough classification such as sedans and wagons, for example, is used as information for specifying a vehicle type, users cannot always find vehicles conforming to the purposes of use of the users. When a finer classification is used as information for specifying a vehicle type so that vehicles conforming to the purposes of use can be retrieved, it may be difficult for users with little knowledge in vehicles to specify a vehicle type. Moreover, the specification of an on-vehicle device (for example, a navigation device, an audio device, or a back monitor) or the presence of the device is different from vehicle to vehicle of the same vehicle type, even when vehicles are retrieved using information for classifying vehicle types as a search condition, such that a vehicle type having an on-vehicle device conforming to the purpose of use cannot always be retrieved.

The purpose of use of a car-sharing car is different from user to user. For example, a certain user may use a car-sharing car for the purpose of moving to a destination, and the other user may use a car-sharing car for the purpose of renting the car-sharing car as a rental space while parking the car-sharing car in a parking lot. Examples of the form of using car-sharing cars as a rental space includes a use form in which users work, rest, lodge, or enjoy audio or video in car-sharing cars and a use form in which users rent car-sharing cars as temporary storage places for luggage. In such use forms of car-sharing cars other than the purpose of mobility, information on the position and the presence of a facility in a parking lot of a car-sharing car or facilities (for example, a restroom, a convenience store, or a bathroom) around the parking lot may be also necessary as information for retrieving vehicles.

Therefore, an object of embodiments of the present disclosure is to propose a reservation management system capable of retrieving car-sharing cars conforming to diverse purposes of use of users easily.

In order to attain the object, a reservation management system according to the present disclosure includes: a vehicle information management unit that manages vehicle information including availability information of each of a plurality of car-sharing cars and information on an on-vehicle device; a facility information management unit that manages facility information on facilities of a parking lot of each of the plurality of car-sharing cars or facilities around the parking lot; a receiving unit that receives, as a search condition for retrieving the car-sharing car, information related to a purpose of use of a user who wants to use a car-sharing car from a communication terminal of the user; a retrieving unit that retrieves one or more candidates for car-sharing cars conforming to the purpose of use among the plurality of car-sharing cars on the basis of the vehicle information and the facility information; a transmitting unit that transmits information related to the retrieved one or more candidates for car-sharing cars to the communication terminal of the user; and a reservation receiving unit that receives a reservation for a car-sharing car selected by the user among the one or more candidates for car-sharing cars.

According to the reservation management system of the present disclosure, it is possible to retrieve car-sharing cars conforming to diverse purposes of use of users easily.

### BRIEF DESCRIPTION OF DRAWINGS

FIG. 1 is an explanatory diagram illustrating a hardware configuration of a reservation management system according, to an embodiment;

FIG. 2 is an explanatory diagram illustrating functional blocks of the reservation management system according to the embodiment; and

FIG. 3 is a flowchart illustrating the flow of processes of a reservation management method according to an embodiment.

### DETAILED DESCRIPTION

Hereinafter, an embodiment will be described with reference to the drawings. Here, the same reference numerals designate the same constituent elements and redundant description will be omitted.

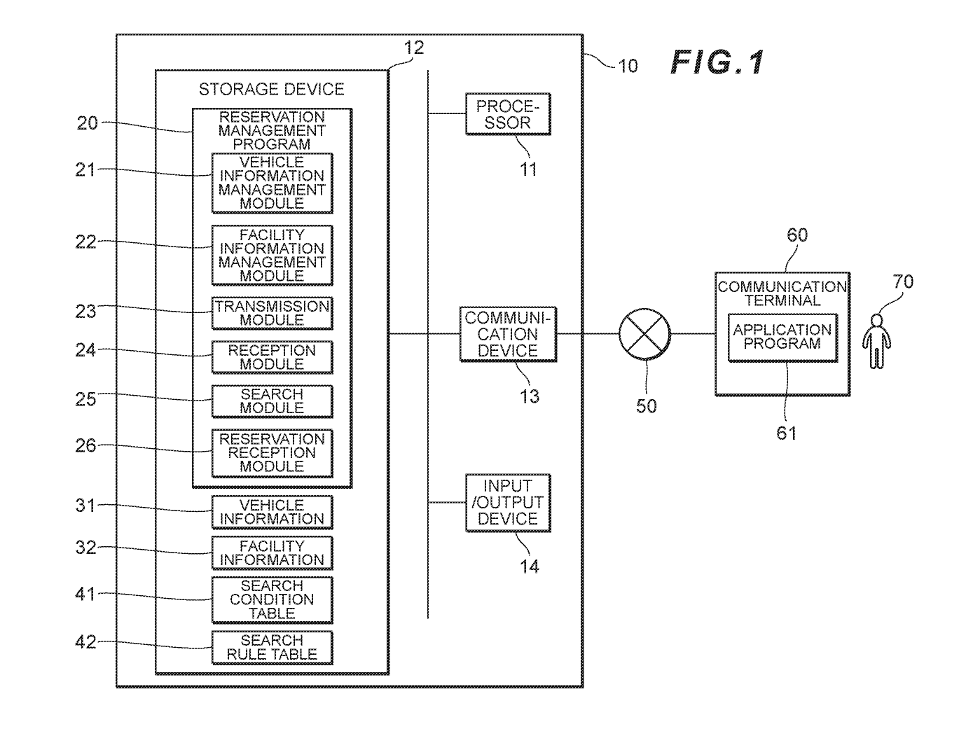

FIG. 1 is an explanatory diagram illustrating a hardware configuration of a reservation management system 10 according to an embodiment. The reservation management system 10 is a computer system (for example, a web server) that receives reservations for car-sharing cars. “Car-sharing cars” mean vehicles provided for use of sharing (for example, common use between members who are users). “Vehicles” include vehicles under road traffic law (for example, automobiles, motor-assisted bicycles, light vehicles, and the like).

The reservation management system 10 includes a processor 11, a storage device 12, a communication device 13, and an input/output device 14 as its hardware resources. The storage device 12 stores a reservation management program 20 that performs a reservation reception process for car-sharing cars and various pieces of data used for this reservation reception process (for example, vehicle information 31, facility information 32, a search condition table 41, a search rule table 42, and the like). The details of these various pieces of data will be described later. The reservation management program 20 includes a vehicle information management module 21, a facility information management module 22, a transmission module 23, a reception module 24, a search module 25, and a reservation reception module 26. These modules are modularized subprograms and the details of the function thereof will be described later. The storage device 12 is a storage resource provided by a non-transitory computer readable medium (for example, a volatile memory, a nonvolatile semiconductor memory, or a disc medium). The communication device 13 is a communication device compatible with a communication standard such as, for example, long-term evolution. The input/output device 14 includes an input device (for example, a keyboard, a mouse, or a touch panel) that inputs information (for example, vehicle information 31 or facility information 32) to the reservation management system 10 and an output device (for example, a display or a printer) that outputs information from the reservation management system 10.

A communication terminal 60 possessed by a user 70 who is a member of car sharing has an application program (for example, a web client) 61 that performs various processes such as inputting, changing, and canceling a reservation for using a car-sharing car. The communication terminal 60 may be a mobile communication terminal having a mobile communication function such as, for example, a multi-functional cellular phone called a smartphone or a tablet terminal or may be a personal computer having a communication function.

The reservation management system 10 and the communication terminal 60 are connected via a communication network 50. The communication network 50 is a communication network, for example, in which a cable network (for example, a local area communication network (LAN), a wide area communication network (WAN), or a value-added communication network (VAN)) and a wireless network (a mobile communication network, a satellite communication network, a Bluetooth (registered trademark) a wireless fidelity (WiFi), or a high speed downlink packet access (HSPDA) are mixed.

The user 70 can connect to the reservation management system 10 from the communication terminal 60 via the communication network 50 and can perform various procedures (receiving, changing, or canceling a reservation) related to reservation of car-sharing cars through a personal authentication procedure. Such procedures are performed by displaying a webpage of a reservation screen on a display of the communication terminal 60 by transmitting and receiving requests and responses conforming to the hypertext transfer protocol between the communication terminal 60 and the reservation management system 10, for example.

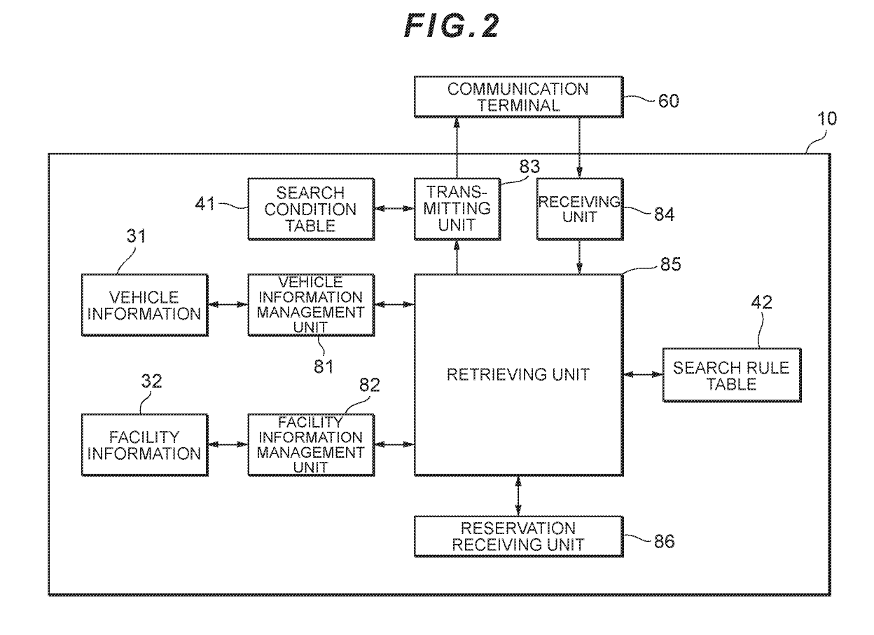

Next, functions of the reservation management system 10 will be described with reference to FIG. 2.

The vehicle information 31 includes availability information of each of a plurality of car-sharing cars. This availability information includes information indicating a reservation state (for example, a reservation date or the like) of each car-sharing car. The vehicle information 31 includes information on an on-vehicle device (for example, a navigation device, an audio device, a back monitor, or a studless tire) of each car-sharing car. The information on the on-vehicle device may include information indicating the specification of an on-vehicle device or the presence thereof. The information indicating the specification of the on-vehicle device may include information indicating the standard (for example, the standard of a disc medium recorded and reproduced by an audio device) of the on-vehicle device or the use (for example, whether a tire is a summer tire or a winter tire) of the on-vehicle device, for example. The vehicle information 31 may further include information indicating a vehicle type of each car-sharing car, image information (for example, an image showing the state inside or outside a vehicle), or the degree of cleanliness.

The vehicle information management module 21 performs a process of managing (for example, updating, adding, and removing) the vehicle information 31. The vehicle information management module 21 is analyzed and executed by the processor 11, and the hardware resources of the reservation management system 10 and the vehicle information management module 21 cooperate, whereby the functions of a vehicle information management unit 81 are realized.

The facility information 32 includes information on facilities of a parking lot of each of a plurality of car-sharing cars or the facilities around the parking lot. The facilities of the parking lot mean, for example, common-use facilities (for example, a restroom, an illumination, a vending machine, or a power supply) provided in the site of the parking lot, and information on the facilities of the parking lot indicates the positions or the number of common facilities. The facilities around the parking lot mean, for example, commercial facilities (for example, a convenience store, a restaurant, a beauty shop, and a coffee shop) or public facilities (for example, stations, bus stops, public restrooms, a park, and public offices) around the site of the parking lot, and the information on the facilities around the parking lot indicates the positions or the number of commercial facilities or public facilities. The facility information 32 may include information (for example, information indicating a public safety level and the degree of quietness in each hour of a day) related to a surrounding environment of the parking lot.

The facility information management module 22 performs a process of managing (for example, updating, adding, and removing) the facility information 32. The facility information management module 22 is analyzed and executed by the processor 11, and the hardware resources of the reservation management system 10 and the facility information management module 22 cooperate whereby the functions of a facility information management unit 82 are realized.

The reception module 24 performs a process of receiving, as a search condition for retrieving the car-sharing car, information related to the purpose of use of the user 70 who wants to use a car-sharing car from the communication terminal 60 of the user 70. The reception module 24 is analyzed and executed by the processor 11 and the hardware resources of the reservation management system 10 and the reception module 24 cooperate whereby the functions of a receiving unit 84 are realized.

The search module 25 performs a process of retrieving one or more candidates for car-sharing cars conforming to the purpose of use and a desired use date and time of the user 70 from a plurality of car-sharing cars on the basis of the vehicle information 31 and the facility information 32. The search module 25 is analyzed and executed by the processor 11 and the hardware resources of the reservation management system 10 and the search module 25 cooperate whereby the functions of a retrieving unit 885 are realized.

The transmission module 23 performs a process of transmitting information related to the retrieved one or more candidates for car-sharing cars to the communication terminal 60 of the user 70. The transmission module 23 is analyzed and executed by the processor 11 and the hardware resources of the reservation management system 10 and the transmission module 23 cooperate whereby the functions of the transmitting unit 83 are realized.

The reservation reception module 26 performs a process of receiving a reservation for a car-sharing car selected by the user 70 among the retrieved one or more candidates for car-sharing cars. The reservation reception module 26 is analyzed and executed by the processor 11 and the hardware resources of the reservation management system 10 and the reservation reception module 26 cooperate whereby the functions of a reservation receiving unit 86 are realized.

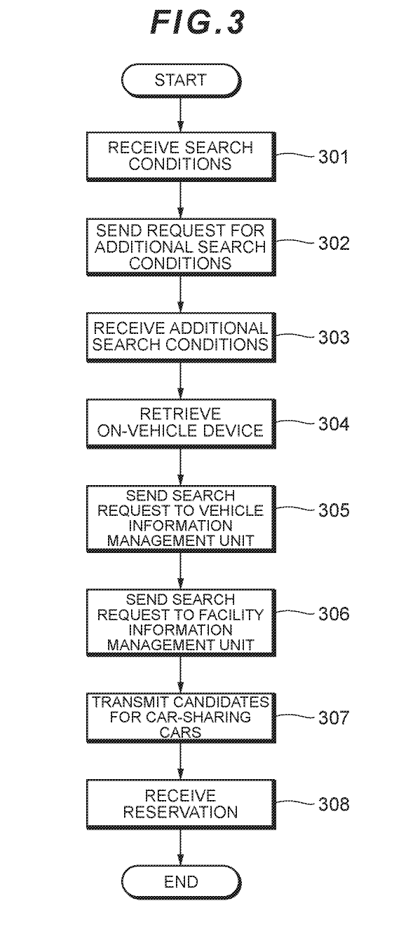

Next, the flow of the processes of a reservation management method according to the present embodiment will be described with reference to FIGS. 2 and 3. It is assumed that prior to the process of step 301, the user 70 has connected to the reservation management system 10 from the communication terminal 60 to the communication network 50 and has accessed a car-sharing car reservation webpage.

In step 301, the receiving unit 84 receives information (for example, information related to a desired use date and time and a purpose of use) related to search conditions for retrieving car-sharing cars conforming to the purpose of use of the user 70 from the communication terminal 60. The purpose of use may be a purpose of riding on a car-sharing car and moving to a destination (for example, a purpose of a drive, a date, a family trip, a work, a shopping, visiting a hospital, or a pickup) or may be a purpose of renting a car-sharing car as a rental space while parking the car-sharing car in a parking lot (for example, a purpose of working, resting, lodging, enjoying audio or video, or temporarily storing luggage). In the search condition table 41, one or more additional search conditions for retrieving an optimal car-sharing car conforming to these various purposes of use are listed for each purpose of use.

In step 302, the transmitting unit 83 requests the communication terminal 60 to transmit the addition search conditions corresponding to the purpose of use by referring to the search condition table 41. For example, when the purpose of the user 70 is a family trip, the transmitting unit 83 may request the communication terminal 60 to transmit additional search conditions such as the number of participants in the family trip, a family structure (for example, the number and the ages of children and the like), and a destination of the family trip. Moreover, when the purpose of use of the user 70 is enjoying of audio or video, the transmitting unit 83 may request the communication terminal 60 to transmit additional search conditions such as the standards (compact disc (CD), digital versatile disc (DVD), Blu-ray Disc, and the like) of a recordable or reproducible disc medium and a reproduction time. For example, the transmitting unit 83 may request the input of additional search conditions interactively using an interactive user interface (for example, chatting using text messages or voice recognition using voice messages).

In step 303, the receiving unit 84 receives additional search conditions corresponding to the purpose of use from the communication terminal 60. The receiving unit 84 may receive the additional search conditions interactively using an interactive user interface, for example. In the search rule table 42, rules for retrieving on-vehicle devices conforming to the purpose of use and the additional search conditions are listed up, for example. The rules may indicate a correspondence between a combination of the purpose of use and the additional search condition and one or more on-vehicle devices conforming to the purpose of use, for example. Moreover, a priority order may be associated with each of one or more on-vehicle devices corresponding to a combination of the purpose of use and the additional search condition. In this manner, by using the additional search condition corresponding to the purpose of use, it is possible to retrieve one or more on-vehicle devices conforming to the purpose of use.

In step 304, the retrieving unit 85 retrieves one or more on-vehicle devices corresponding to a combination of the purpose of use and the additional search condition by referring to the search rule table 42. The retrieving unit 85 may associate a priority order with each of the retrieved one or more on-vehicle devices. For example, when the purpose of use of the user 70 is a family trip, the retrieving unit 85 retrieves one or more on-vehicle devices (for example, a studless tire, a television receiver, and the like) conforming to the number of participants in the family trip, a family structure (for example, the number and the ages of children and the like), and a destination of the family trip. Moreover, when the purpose of use of the user 70 is enjoying of audio or video, the retrieving unit 85 retrieves one or more on-vehicle devices (for example, a DVD reproduction device and the like) conforming to the standards of a recordable or reproducible disc medium and a reproduction time.

In step 305, the retrieving unit 85 requests the vehicle information management unit 81 to retrieve car-sharing cars including one or more on-vehicle devices retrieved in step 304. The vehicle information management unit 81 retrieves one or more car-sharing cars including one or more on-vehicle devices retrieved in step 304 among one or more car-sharing cars available on the desired date and time of the user 70 by referring to the vehicle information 31. The vehicle information management unit 81 may refine search by leaving car-sharing cars including an on-vehicle device having a high priority order as candidates and removing car-sharing cars including an on-vehicle device having a low priority order so that a predetermined or smaller number of car-sharing cars are retrieved. For example, when the purpose of verse of the user 70 is enjoying of audio or video, the retrieving unit 85 may refine search by leaving car-sharing cars including an audio device having a high acoustic performance as candidates and removing car-sharing cars including an audio device having a low acoustic performance. The vehicle information management unit 81 returns a retrieval result of car-sharing cars to the retrieving unit 85.

In step 306, the retrieving unit 85 requests the facility information management unit 82 to retrieve car-sharing cars parking in a parking lot having a facility conforming to the purpose of use or car-sharing cars parking in a parking lot around a facility conforming to the purpose of use. In the search rule table 42, correspondence between the purpose of use and one or more facilities conforming to the purpose of use may be listed up, and a priority order may be associated with each of one or more facilities. For example, the facility information management unit 82 retrieves one or more car-sharing cars parking in a parking lot having a facility conforming to the purpose of use or one or more car-sharing cars parking in a parking lot around the facility conforming to the purpose of use among one or more car-sharing cars retrieved in step 305 by referring to the facility information 32 and the search rule table 42. The facility information management unit 82 may refine search by removing car-sharing cars parking in a parking lot having a facility having a low priority order or car-sharing cars parking in a parking lot around the facility having a low priority order so that a predetermined or smaller number of car-sharing cars are retrieved. The facility information management unit 82 returns a retrieval result of car-sharing cars to the retrieving unit 85.

In step 307, the transmitting unit 83 transmits information related to one or more candidates for car-sharing cars retrieved in step 306 to the communication terminal 60. The one or more candidates for car-sharing cars may be arranged in descending order of priority orders.

In step 308, the reservation receiving unit 86 receives a reservation for the car-sharing car selected by the user 70 among the one or more candidates for car-sharing cars transmitted in step 307.

According to the embodiment, it is possible to retrieve car-sharing cars conforming to diverse purposes of use of the user 70 easily and accurately. Particularly, regardless of whether the purpose of use of the user 70 is a purpose of riding on a car-sharing car and moving to a destination or a purpose of renting a car-sharing car as a rental space while parking the car-sharing car in a parking lot, it is possible to retrieve car-sharing cars conforming to purposes of use of the user 70 accurately. In this way, it is possible to suppress mismatch between a car-sharing car optimal to the purpose of use of the user 70 and a car-sharing car actually rented to the user 70 and to provide comfortable use of car-sharing cars. Moreover, when the purpose of use of the user 70 is other than the purpose of riding on a car-sharing car and moving to a destination, since the candidate car-sharing cars to be rented to the user 70 are not limited to those capable of traveling on public roads under the law, the candidate car-sharing car may be vehicles of which the safety inspection period has expired and vehicles which are waiting for maintenance. Furthermore, since automobile insurance is not required, it is advantageous for a car sharing business operator to effectively use available vehicles. Moreover, by reinforcing facilities of such an available vehicle, it is possible to provide a car-sharing car conforming to purposes other than the purpose of mobility to the user 70. Furthermore, when the user 70 uses a car-sharing car, the user 70 can rent the car-sharing car at a low cost since insurance and gas are not required.

The embodiment described hereinabove is provided to facilitate the understanding of the present disclosure and is not to be construed as limiting the present disclosure. Tho present disclosure can be changed or modified without departing from the gist thereof and also encompasses equivalents thereof. For example, the same functions as the functions of the vehicle information management module 21, the facility information management module 22, the transmission module 23, the reception module 24, the search module 25, and the reservation reception module 26 may be realized using firmware or a dedicated hardware resource (for example, an application-specific integrated circuit (ASIC) or a field programmable gate array (FPGA)). The reservation management program 20 may be encoded in a predetermined signal format and be transmitted from a certain computer system to another computer system through a transmission medium (a cable communication network) or transmission waves (radio waves). Moreover, the function of the reservation management system 10 is not necessarily realized by one computer system but may be realized by a plurality of computer systems connected to the communication network 50.

What is claimed is:

1. A reservation management system comprising:
a vehicle information management unit that manages vehicle information including availability information of each of a plurality of car-sharing cars and information on an on-vehicle device;
a facility information management unit that manages facility information on facilities of a parking lot of each of the plurality of car-sharing cars or facilities around the parking lot;
a receiving unit that receives, as a search condition for retrieving the car-sharing car, information related to a purpose of use of a user who wants to use a car-sharing car from a communication terminal of the user;
a retrieving unit that retrieves one or more candidates for car-sharing cars conforming to the purpose of use among the plurality of car-sharing cars on the basis of the vehicle information and the facility information;
a transmitting unit that transmits information related to the retrieved one or more candidates for car-sharing cars to the communication terminal of the user; and
a reservation receiving unit that receives a reservation for a car-sharing car selected by the user among the one or more candidates for car-sharing cars.

2. The reservation management system according to claim 1, wherein
the receiving unit receives additional search conditions corresponding to the purpose of use interactively from the communication terminal of the user.

3. The reservation management system according to claim 1, wherein
the purpose of use includes a purpose other than a purpose of the user riding on the car-sharing car and moving to a destination.

4. A reservation management method for causing a computer system to execute the steps of:
managing vehicle information including availability information of each of a plurality of car-sharing cars and information on an on-vehicle device;
managing facility information on facilities of a parking lot of each of the plurality of car-sharing cars or facilities around the parking lot;
receiving, as a search condition for retrieving the car-sharing car, information related to a purpose of use of a user who wants to use a car-sharing car from a communication terminal of the user;
retrieving one or more candidates for car-sharing cars conforming to the purpose of use among the plurality of car-sharing cars on the basis of the vehicle information and the facility information;
transmitting information related to the retrieved one or more candidates for car-sharing cars to the communication terminal of the user; and
receiving a reservation for a car-sharing car selected by the user among the one or more candidates for car-sharing cars.

5. A non-transitory computer readable medium storing a reservation management program thereon, the program causing a computer system to execute the reservation management method according to claim 4.
